(19) United States
(12) Patent Application Publication
(10) Pub. No.: US 2019/0010016 A1
(43) Pub. Date: Jan. 10, 2019

(54) ELEVATOR CAR POSITION DETECTION ASSEMBLY

(71) Applicant: OTIS ELEVATOR COMPANY, Farmington, CT (US)

(72) Inventors: Tadeusz Pawel Witczak, Bethel, CT (US); Zbigniew Piech, Cheshire, CT (US); Wojciech Szelag, Poznan (PL); Cezary Jedryczka, Lniano (PL); Richard N. Fargo, Plainville, CT (US); Dang V. Nguyen, South Windsor, CT (US); Peter DePaola, Jr., South Windsor, CT (US)

(21) Appl. No.: 15/750,576

(22) PCT Filed: Aug. 10, 2016
(86) PCT No.: PCT/US2016/046230

§ 371 Date: Feb. 6, 2018

Related U.S. Application Data
(60) Provisional application No. 62/205,271, filed on Aug. 14, 2015.

(51) Int. Cl. B66B 1/34; B66B 5/00; B66B 11/04; G01D 5/243

(52) U.S. Cl. CPC B66B 1/3492; B66B 5/0018; B66B 9/003; G01D 5/243; B66B 11/0407

(57) ABSTRACT

An elevator system includes a car disposed in and constructed and arranged to move along a hoistway that includes a centerline and is defined by a stationary structure. A plurality of position sensors of a position detection assembly are configured to be stationary with respect to the stationary structure and are spaced along the hoistway. The plurality of position sensors are configured to measure a magnetic field characteristic associated with the car, and thereby provide continuous car position data to the elevator system.

### BACKGROUND

The subject matter disclosed herein relates generally to the field of elevators, and more particularly to a car position detection assembly of an elevator system.

Self-propelled elevator systems, also referred to as ropeless elevator systems, are useful in certain applications (e.g., high rise buildings) where the mass of the ropes for a roped system is prohibitive and there is a desire for multiple elevator cars to travel in a single lane. There exist self-propelled elevator systems in which a first lane is designated for upward traveling elevator cars and a second lane is designated for downward traveling elevator cars. At least one transfer station is provided in the hoistway to move cars horizontally between the first lane and second lane. With the relatively new concept of ropeless elevators, improved means of detecting car positions is desirable since the linear motors that propel ropeless elevators may be distributed along the hoistway, no physical connection exists between the car and motor, and more than one car may be in any one hoistway.

### SUMMARY

An elevator system according to one, non-limiting, embodiment of the present disclosure includes a car disposed in and constructed and arranged to move along a hoistway including a centerline and defined by a stationary structure; and a plurality of position sensors configured to be stationary with respect to the stationary structure and spaced along the hoistway, and wherein the plurality of position sensors are configured to measure a magnetic field characteristic associated with the car.

Additionally to the foregoing embodiment, the elevator system includes a linear propulsion system configured to impart force upon the car in an axial direction, the linear propulsion system including a secondary portion mounted to the car that includes a first plurality of magnets, and a primary portion that includes a mounting assembly and a plurality of coils engaged to the mounting assembly.

In the alternative or additionally thereto, in the foregoing embodiment, the position sensors are generally disposed away from the first plurality of magnets such that they are not affected by a magnetic field of the first plurality of magnets

In the alternative or additionally thereto, in the foregoing embodiment, the magnetic field characteristic is a magnetic field interaction between a first magnetic field generated by at least one coil of the plurality of coils and a second magnetic field generated by at least one magnet of the first plurality of magnets.

In the alternative or additionally thereto, in the foregoing embodiment, the elevator system including at least one second magnet secured to the car and not associated with the first plurality of magnets, and wherein the magnetic field characteristic is a magnetic field of the at least one second magnet.

In the alternative or additionally thereto, in the foregoing embodiment, a first magnetic field is generated by at least one coil of the plurality of coils, a second magnetic field is generated by at least one magnet of the first plurality of magnets and a third magnetic field is generated by the at least one second magnet, and wherein the at least one second magnet is generally positioned such that the third magnetic field is not affected by the first and second magnetic fields

In the alternative or additionally thereto, in the foregoing embodiment, the at least one second magnet is a plurality of second magnets of a magnetic tape extending axially.

In the alternative or additionally thereto, in the foregoing embodiment, the plurality of position sensors are directly engaged to the mounting assembly.

In the alternative or additionally thereto, in the foregoing embodiment, the at least one second magnet is disposed radially inward from the first plurality of magnets and the plurality of coils.

In the alternative or additionally thereto, in the foregoing embodiment, the plurality of position sensors are disposed radially outward from the at least one second magnet, and radially inward from the plurality of coils.

In the alternative or additionally thereto, in the foregoing embodiment, the plurality of position sensors are engaged to the mounting assembly.

In the alternative or additionally thereto, in the foregoing embodiment, the mounting assembly includes a first panel for supporting the plurality of coils, and projecting radially inward from the stationary structure and to a distal face carried at least in-part by the first panel and that extends axially and faces radially inward, and wherein the plurality of position sensors are engaged to the distal face.

In the alternative or additionally thereto, in the foregoing embodiment, the mounting assembly includes an end cap and a second panel with the plurality of coils mounted between the first and second panels, and the end cap extending between and joining the first and second panels, and wherein the distal face is carried by the end cap.

In the alternative or additionally thereto, in the foregoing embodiment, the secondary portion includes a third plurality of magnets with the plurality of coils and at least a portion of the first and second panels disposed between and spaced from the first and third plurality of magnets.

In the alternative or additionally thereto, in the foregoing embodiment, each one of the plurality of position sensors include at least one electrical lead routed through a conduit defined between the first and second panels.

In the alternative or additionally thereto, in the foregoing embodiment, the at least one second magnet is disposed radially outward from the first plurality of magnets and the plurality of coils.

In the alternative or additionally thereto, in the foregoing embodiment, the plurality of position sensors are disposed radially outward from the at least one second magnet and from the plurality of coils.

In the alternative or additionally thereto, in the foregoing embodiment, the plurality of position sensors are engaged to the mounting assembly.

In the alternative or additionally thereto, in the foregoing embodiment, the mounting assembly includes a bracket engaged to the stationary structure and a panel projecting radially inward from and engaged to the bracket, wherein the plurality of coils are mounted to the panel, and wherein the plurality of position sensors are engaged to the bracket.

In the alternative or additionally thereto, in the foregoing embodiment, each one of the plurality of position sensors include an electrical lead, and wherein the bracket is at least in-part a bus for routing the electrical leads.

In the alternative or additionally thereto, in the foregoing embodiment, the at least one second magnet is a second plurality of magnets having a pole pitch that is equal to a pole pitch of the first plurality of magnets divided by an integer of two or greater.

A position detection assembly for determining the position of an elevator car configured to travel in a hoistway defined by a stationary structure, the position detection assembly including at least one hall effect sensor disposed in the hoistway and engaged to one of the car and the stationary structure; and at least one magnet disposed in the hoistway and engaged to the other of the car and the stationary structure, the at least one magnet including a magnetic field detectable by the at least one hall effect sensor for continuous position determination of the car within the hoistway.

A method of determining a position of an elevator car according to another, non-limiting, embodiment including sensing a magnetic field characteristic by a sensor secured to a hoistway, wherein the magnetic field characteristic is created at least in part by a permanent magnet of a propulsion system carried by the elevator car; and comparing an output of the sensor to a pre-established tabulation based on current and phase angle intervals preprogramed into a controller.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 depicts a multicar elevator system in an exemplary embodiment;

FIG. 2 is a top down view of a car and portions of a linear propulsion system in an exemplary embodiment;

FIG. 3 is a cross section of the linear propulsion system in an exemplary embodiment;

FIG. 4 is a schematic of the linear propulsion system illustrating a position detection assembly;

FIG. 5 is a partial exploded view of a primary portion of the linear propulsion system;

FIG. 6 is a partial perspective view of the primary portion;

FIG. 7 is a partial perspective view of a primary portion of a second embodiment of a linear propulsion system illustrating;

FIG. 8 is a cross section of the linear propulsion system of FIG. 7;

FIG. 9 is a front view of a magnetic tape of the linear propulsion system of FIG. 7.

FIG. 10 is a cross section of a third embodiment of a linear propulsion system; and

FIG. 11 is a partial perspective view of a primary portion of the linear propulsion system of FIG. 10.

### DETAILED DESCRIPTION

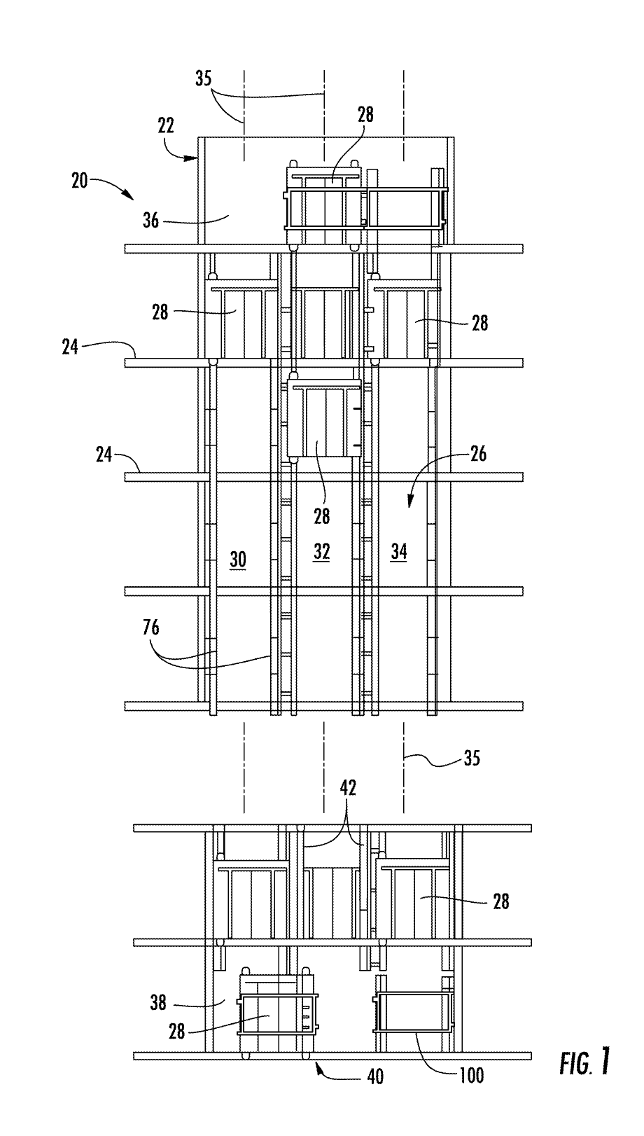

FIG. 1 depicts a self-propelled or ropeless elevator system 20 in an exemplary embodiment that may be used in a structure or building 22 having multiple levels or floors 24. Elevator system 20 includes a hoistway 26 having boundaries defined by the structure 22 and at least one car 28 adapted to travel in the hoistway 26. The hoistway 26 may include, for example, three lanes 30, 32, 34 each extending along a respective centerline 35 with any number of cars 28 traveling in any one lane and in any number of travel directions (e.g., up and down). For example and as illustrated, the cars 28 in lanes 30, 34, may travel in an up direction and the cars 28 in lane 32 may travel in a down direction.

Above the top floor 24 may be an upper transfer station 36 that facilitates horizontal motion to elevator cars 28 for moving the cars between lanes 30, 32, 34. Below the first floor 24 may be a lower transfer station 38 that facilitates horizontal motion to elevator cars 28 for moving the cars between lanes 30, 32, 34. It is understood that the upper and lower transfer stations 36, 38 may be respectively located at the top and first floors 24 rather than above and below the top and first floors, or may be located at any intermediate floor. Yet further, the elevator system 20 may include one or more intermediate transfer stations (not illustrated) located vertically between and similar to the upper and lower transfer stations 36, 38.

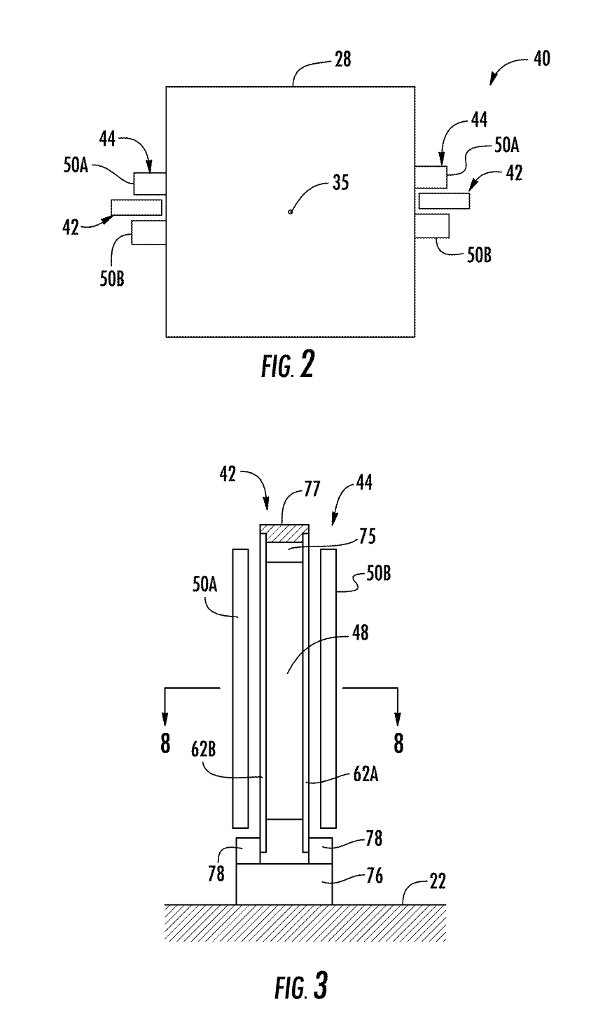

Referring to FIGS. 1 through 3, cars 28 are propelled using a linear propulsion system 40 having at least one, fixed, primary portion 42 (e.g., two illustrated in FIG. 2 mounted on opposite sides of the car 28), moving secondary portions 44 (e.g., two illustrated in FIG. 2 mounted on opposite sides of the car 28), and a control system 46 (see FIG. 4). The primary portion 42 includes a plurality of windings or coils 48 mounted at one or both sides of the lanes 30, 32, 34 in the hoistway 26. Each secondary portion 44 includes two rows of opposing permanent magnets 50A, 50B mounted to the car 28. Primary portion 42 is supplied with drive signals from the control system 46 to generate a magnetic flux that imparts a force on the secondary portions 44 to control movement of the cars 28 in their respective lanes 30, 32, 34 and generally in an axial direction with respect to centerline 35 (e.g., moving up, down, or holding still). The plurality of coils 48 of the primary portion 42 are generally located between and spaced from the opposing rows of permanent magnets 50A, 50B. It is contemplated and understood that any number of secondary portions 44 may be mounted to the car 28, and any number of primary portions 42 may be associated with the secondary portions 44 in any number of configurations.

Referring to FIG. 4, the control system 46 may include power sources 52, drives 54, buses 56 and a controller 58. The power sources 52 are electrically coupled to the drives 54 via the buses 56. In one non-limiting example, the power sources 52 may be direct current (DC) power sources. DC power sources 52 may be implemented using storage devices (e.g., batteries, capacitors), and may be active devices that condition power from another source (e.g., rectifiers). The drives 54 may receive DC power from the buses 56 and may provide drive signals to the primary portions 42 of the linear propulsion system 40. Each drive 54 may be a converter that converts DC power from bus 56 to a multiphase (e.g., three phase) drive signal provided to a respective section of the primary portions 42. The primary portion 42 is divided into a plurality of modules or sections, with each section associated with a respective drive 54.

The controller 58 provides control signals to each of the drives 54 to control generation of the drive signals. Controller 58 may use pulse width modulation (PWM) control signals to control generation of the drive signals by drives 54. Controller 58 may be implemented using a processor-based device programmed to generate the control signals. The controller 58 may also be part of an elevator control system or elevator management system. Elements of the control system 46 may be implemented in a single, integrated module as described further below, and/or be distributed along the hoistway 26.

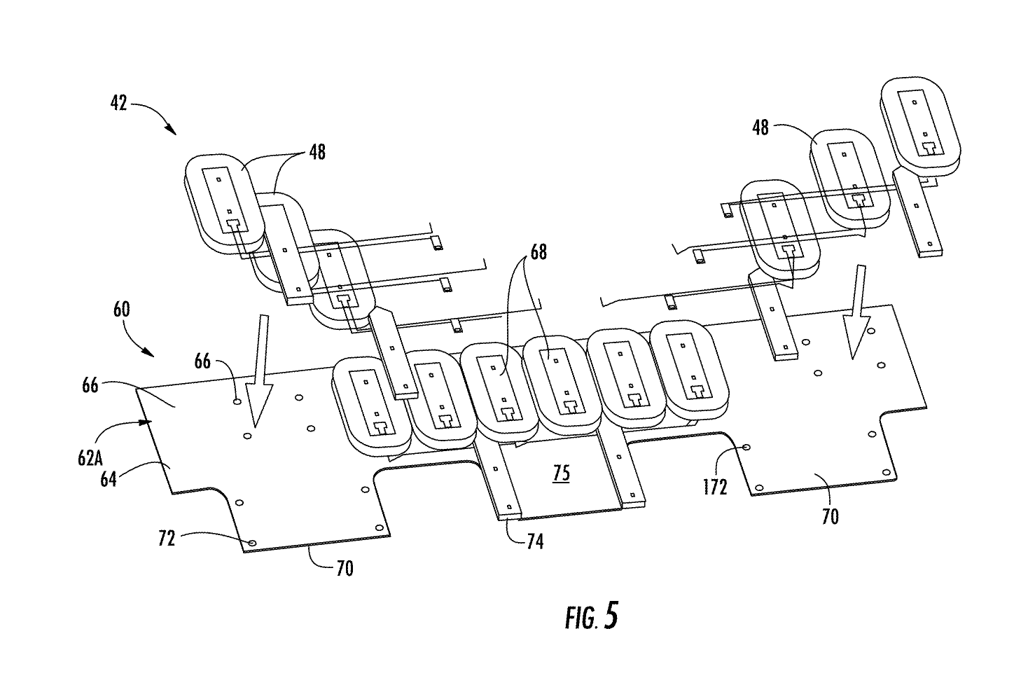

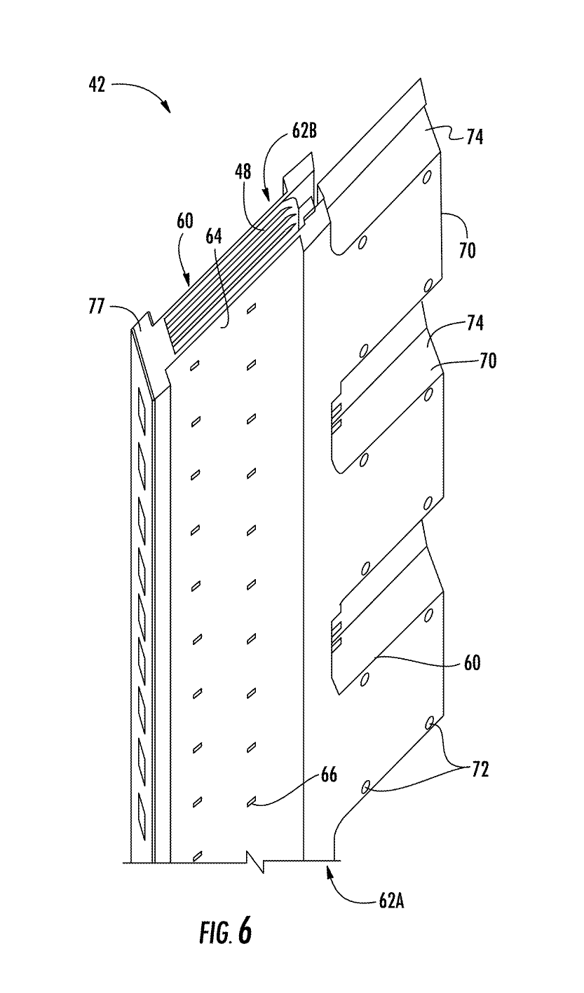

Referring to FIGS. 5 and 6, the primary portion 42 may include a mounting assembly 60 that supports the coils 48. The mounting assembly 60 may include opposing panels 62A, 62B each having a substantially planar base 64 that may be generally rectangular with a plurality of mounting holes 66 formed therein. Coil cores 68 of the mounting assembly 60 support the coils 48, and may be secured to the base 64 of one or both panels 62A, 62B and at the mounting holes 66 via fasteners (not shown). The panels 62A, 62B and the coil cores 68 may be made from a non-conductive material, such as fiberglass, plastic and/or fiber impregnated plastic.

One or more flanges 70 of each panel 62A, 62B may be located co-planar too, and extend from, the base 64. Each flange 70 may include mounting holes 72 for securing spacers 74 of the mounting assembly 60 at outer edges of the flanges 70 using fasteners (not shown). When assembled, the flanges 70 with the spacers 74 provide a conduit 75 to accommodate electrical wiring to the coils 48 of the primary portion 42. The flanges 70 may also provide desired rigidity for the primary portion 42.

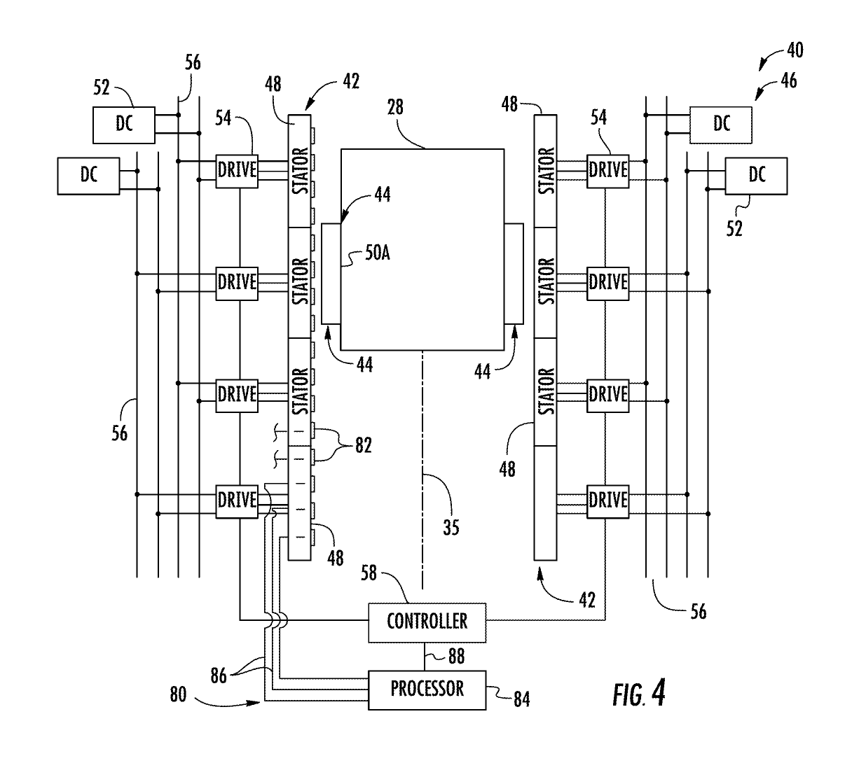

The bases 64 of each panel 62A, 62B project radially inward with respect to centerline 35, from the respective flanges 70, and to a distal edge of each base 64 that spans longitudinally in an axial direction. An end spacer or end cap 77 spans laterally between the distal edges of each base 64 to encapsulate or generally cover the coils 48. Similarly, the bases 64 of each panel 62A, 62B and the end cap 77 may define at least in-part a continuation of the conduit 75 (also see FIG. 3) to accommodate electrical wiring and/or leads.

Referring to FIGS. 1, 3 and 6, the linear propulsion system 40 of the elevator system 20 may further include a rail 76, and the mounting assembly 60 of the primary portion 42 may further include a bracket 78 that may be engaged to and between the panel 62 and the rail 76. As one non-limiting example, two rails 76 may respectively oppose opposite sides of the car 28, and may substantially extend vertically in each lane 30, 32, 34 of the hoistway 26 (i.e., extends axially with respect to axis 35).

Referring to FIG. 4, the linear propulsion system 40 may further include a position detection assembly 80 that may include a plurality of position sensors 82 and a processor or controller 84 that may be electronic and may communicate with or is integrated into the controller 58. Each position sensor 82 may have a communication pathway 86 that may be wired (e.g., a wire lead) or wireless for communication with the processor 84. The sensors 82 are stationary with respect to the stationary structure 22 and may be spaced from one another in an axial direction along the entire length of each lane 30, 32, 34 of the hoistway 26. Each sensor 82 may be a transducer that varies an output voltage in response to a magnetic field. One such example of a transducer may include a Hall sensor.

In one, non-limiting, example, the position sensors 82 may directly measure the magnetic field angle from the permanent magnets 50A and/or magnets 50B of the secondary portion 44 as the car 28 (and the secondary portion 44) passes each position sensor 82. More specifically, the sensors 82 may detect a magnetic characteristic or field that may be produced by the interaction of the magnetic fields produced by the primary and secondary portions 42, 44. The position sensors 82 may be embedded directly into the mounting assembly 60 of the primary portions 42, or otherwise adhered thereto. Because the sensors 82 are orientated at known positions along each lane 30, 32, 34, a direct high bandwidth wired field orientation feedback to the control loop of the elevator system 20 is provided without the need for a conversion from an alternative sensing method, such as sensors positioned only at a landing. Because the stationary location of the position sensors 82 is known relative to the car 28 and stationary structure 22 (i.e., hoistway 26), the present position sensing method may be applied to position feedback for vehicle control over communication pathway 88 extending between the controller 58 and the position processor 84.

The position sensors 82 may be grouped as a magnetic field sensor array (MFSA), and may generally operate in two modes or scenarios. The first mode is when the elevator car 28 is stationary and no current is provided to the coils of the primary portions 42. In the first mode, the sensors 82 (or MFSA) are directly exposed to the magnetic field of the permanent magnets 50A, 50B and may directly sense the location of the north and south magnetic poles of the magnets 50A, 50B.

As the second mode, the elevator car 28 may be in operation and electrical current is flowing through the primary portions 42. For the second mode, the MFSA outputs for an array of values of motor current and phase angle are experimentally or analytically read when the permanent magnets 50A, 50B are not present. A tabulation (i.e., reference chart) may be developed and conducted in intervals of about one amp and in angle intervals of about five degrees, as one non-limiting example. For each of the current/phase angle conditions, the output values of the MFSA may be read. Use of the table created for current/angle conditions and finding the electrical angle of the magnets in the table will, through interpolation, provide additional resolution. By using this process, the drives 54 may determine which of the sensors 82 are not in the vicinity of the magnets 50A, 50B, and also where the magnets are relative to the engaged sensors. This results in a calculation of the car position. Since there will be multiple MFSAs along the length of the primary portions 42, the calculated position can be averaged to increase the accuracy of the measurement.

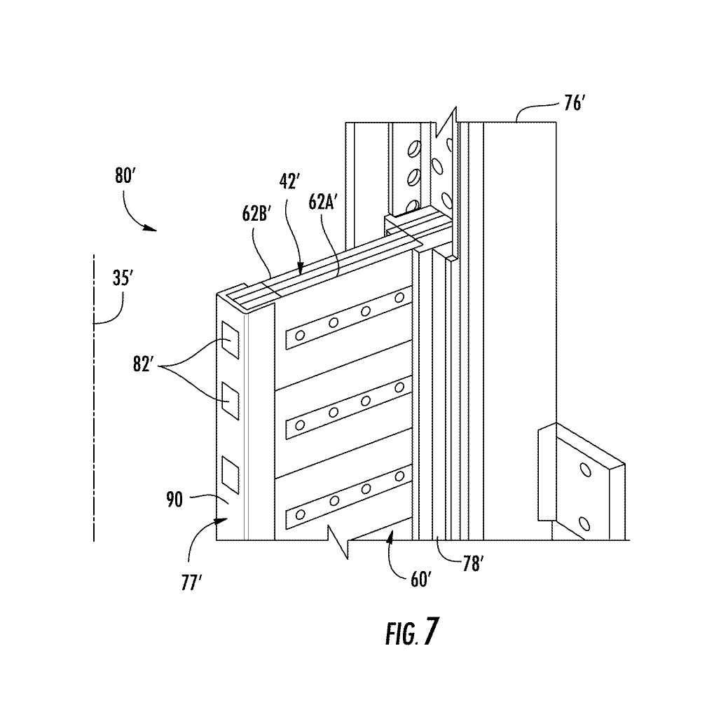

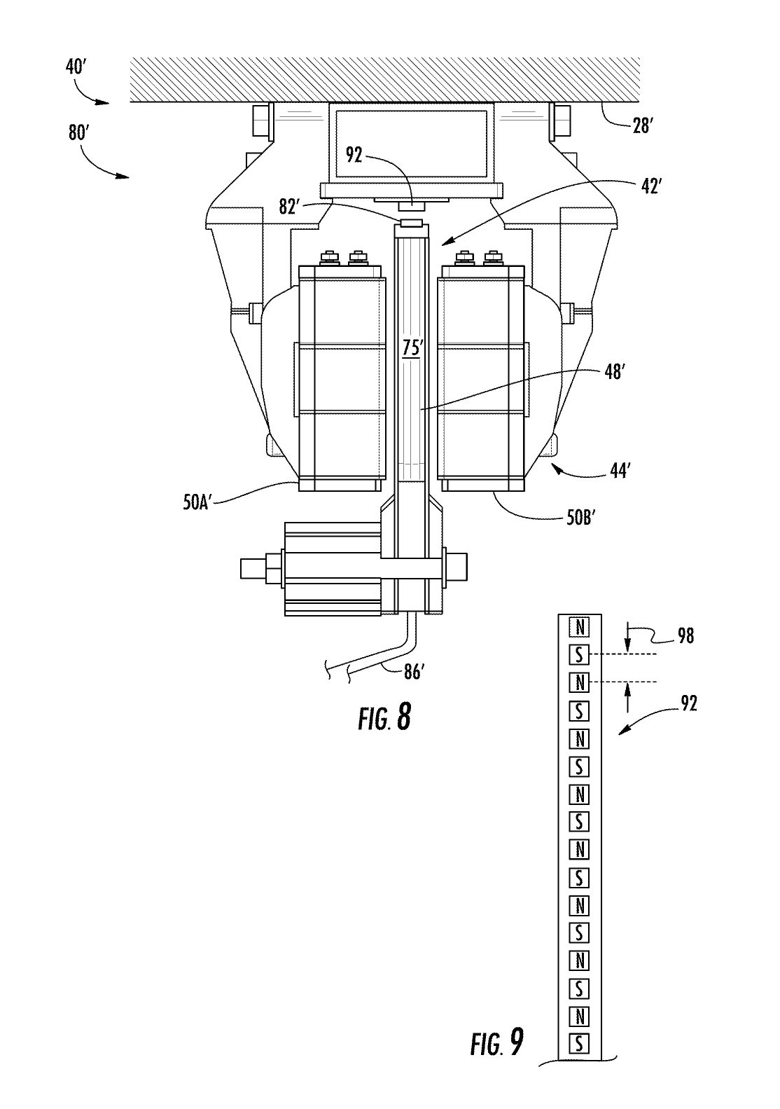

Referring to FIGS. 7 through 9, a second embodiment of a linear propulsion system is illustrated wherein like elements of the first embodiment have like element numbering except with the addition of a prime symbol suffix. A linear propulsion system 40′ may include a position detection assembly 80′ that may include a plurality of position sensors 82′ engaged to or embedded in a face 90 that may be carried by an end cap 77′ and may face substantially radially inward with respect to a centerline 35′. The position detection assembly 80′ may further include at least one permanent magnet 92 that is engaged to and travels with a car 28′. The magnet 92 may further be a plurality of magnets equally and axially spaced from one-another along the car 28′ for further refinement of car position detection. The plurality of magnets 92 may be a magnetic tape (see FIG. 9) that may further be adhered to a secondary portion 44′ of the linear propulsion system 40′.

The placement and orientation of the position sensors 82′ and the magnets 92 of the position detection assembly 80′ is such where the magnetic fields produced by the primary and secondary portions 42′, 44′ will not interfere (e.g., harmonic interference) with the position detection magnetic field. The magnets 92 of the position detection assembly 80′ may be located radially inward from coils 48′ of a primary portion 42′, radially inward from permanent magnets 50A′, 50B′ of the secondary portion 44′, and spaced slightly radially inward from the position sensors 82′. A pole pitch 98 (see FIG. 9) may be equal to a pole pitch of the plurality of magnets 50A′ divided by an integer of two or greater. In this way, the signals created by the sensors 82′ will have a distinguishably different, fundamental, frequency (i.e., twice or more times higher) than the main magnetic field produced by the interaction of the propulsion primary and secondary portions 42′, 44′. Wire lead(s) 86′ of each sensor 82′ may be conveniently routed through a conduit 75′.

The position sensors 82′ may directly measure the magnetic field from the permanent magnets 92 secured to the secondary portion 44′ as the car 28′ (and the secondary portion 44′) passes each position sensor 82′. Because each car 28′ may include a number of measurement points as dictated by the positioning of the multitude of magnets 92, redundancy is added to the elevator system. The redundant data may further be processed to determine potential car imbalance.

The primary portion 42′ may be a modular unit of the linear propulsion system 40′ each having a set number of coils 48′ and position sensors 82′. The linear propulsion system 40′ may include a plurality of modular primary portions 42′ generally aligned top to bottom along the common rail 76′ that may extend along the entire vertical height of the respective lanes. The coils 48′ of each primary portion 42′ may be driven by a single, respective drive. In other embodiments, a drive may provide drive signals to coils 48′ in multiple primary portions 42′. The modular nature of the primary portions 42′ facilitates installation of the primary portions 42′ along the length of the rail 76′ in the hoistway. Installers need only to handle the modular primary portions 42′, which are less cumbersome than more traditional designs. It is further understood and contemplated that various configurations and numbers of the primary portions 42′ and components thereof may constitute a modular unit.

It is further contemplated that a module application facilitates expansion of the position detection assembly 80′. For example, as a building is constructed or expands in height, the position detection assembly 80′ and as a module unit may likewise expand. Averaging readings from one or more position sensors of one module as well as different modules may add to redundancy and safety. The averaging of readings may be achieved from more than one side of the elevator car. Verifying spacing between stationary hoistway structures based on position sensor signals from different module may be facilitated. For example, the sensors may monitor a gap between transfer station and lane propulsion modules.

Because of the contactless position sensing capability of the position detection assembly 80′, continuous sensing may be applied while the car 28′ is moving into a transfer station 38 (see FIG. 1). Additional check signals from, for example, a first sensor 82′ may be used to verify a gap between a transfer station carriage 100 (see FIG. 1) and the structure 22 defining any one lane. Moreover, the same magnets 92 of the same car may be used in any lane 30, 32, 34. It is further contemplated and understood the magnets 92 and the position sensors 82′ may be reversed with the magnets 92 secured to the primary portion 42′ and the sensors secured to the car 28′.

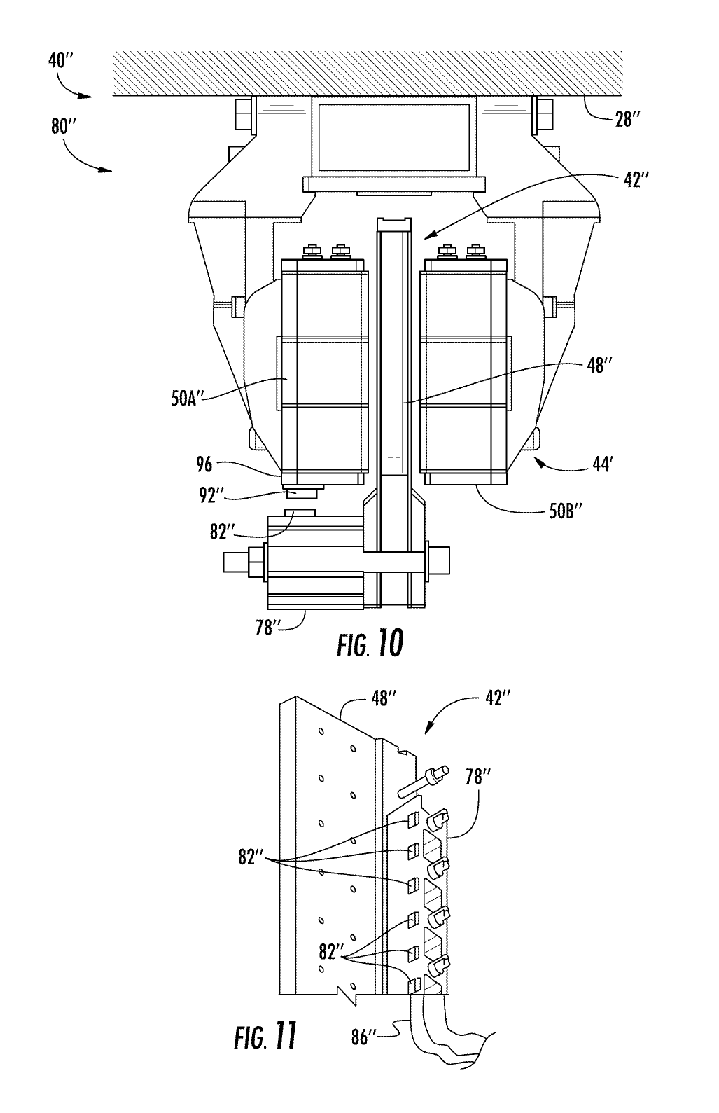

Referring to FIGS. 10 and 11, a third embodiment of a linear propulsion system is illustrated wherein like elements of the first and second embodiment have like element numbering except with the addition of a double prime symbol suffix. A linear propulsion system 40″ may include a position detection assembly 80″ that may include a plurality of position sensors 82″ engaged to or embedded in a bracket 78″ that may also function as a bus for routing a multitude of wire leads 86″ from the sensors 82″. The position detection assembly 80″ may further include at least one permanent magnet 92″ that is engaged to and travels with a car 28″. The magnet 92″ may further be a plurality of magnets equally and axially spaced from one-another along the car 28″ for further refinement of car position detection. The plurality of magnets 92″ may be a magnetic tape (see FIG. 9) that may further be adhered to a secondary portion 44″ of the linear propulsion system 40″. More specifically, the magnets 92″ may be secured to a housing 96 of the secondary portion 44″ that directly supports the magnets 50A″ of the secondary portion 44″.

The placement and orientation of the position sensors 82″ and the magnets 92″ of the position detection assembly 80″ is such where the magnetic fields produced by the primary and secondary portions 42″, 44″ will not interfere with the position detection magnetic field. The magnets 92″ of the position detection assembly 80″ may be located radially outward from coils 48″ of a primary portion 42″, radially outward from permanent magnets 50A″, 50B″ of the secondary portion 44″, and spaced slightly radially inward from the position sensors 82″. It is further contemplated and understood that the position sensors may be mounted independently from the panels 62 and rails 76 (e.g., hoistway wall) but with defined reference to the propulsion, guidance and/or support modules.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. An elevator system, comprising:
a car disposed in and constructed and arranged to move along a hoistway including a centerline and defined by a stationary structure; and
a plurality of position sensors configured to be stationary with respect to the stationary structure and spaced along the hoistway, and wherein the plurality of position sensors are configured to measure a magnetic field characteristic associated with the car.

2. The elevator system set forth in claim 1 further comprising:
a linear propulsion system configured to impart force upon the car in an axial direction, the linear propulsion system including a secondary portion mounted to the car that includes a first plurality of magnets, and a primary portion that includes a mounting assembly and a plurality of coils engaged to the mounting assembly.

3. The elevator system set forth in claim 2, wherein the position sensors are generally disposed away from the first plurality of magnets such that they are not affected by a magnetic field of the first plurality of magnets.

4. The elevator system set forth in claim 2, wherein the magnetic field characteristic is a magnetic field interaction between a first magnetic field generated by at least one coil of the plurality of coils and a second magnetic field generated by at least one magnet of the first plurality of magnets.

5. The elevator system set forth in claim 2, further comprising:
at least one second magnet secured to the car and not associated with the first plurality of magnets, and wherein the magnetic field characteristic is a third magnetic field of the at least one second magnet.

6. The elevator system set forth in claim 5, wherein a first magnetic field is generated by at least one coil of the plurality of coils, a second magnetic field is generated by at least one magnet of the first plurality of magnets and a third magnetic field is generated by the at least one second magnet, and wherein the at least one second magnet is generally positioned such that the third magnetic field is not affected by the first and second magnetic fields.

7. The elevator system set forth in claim 5, wherein the at least one second magnet is a plurality of second magnets of a magnetic tape extending axially.

8. The elevator system set forth in claim 4, wherein the plurality of position sensors are directly engaged to the mounting assembly.

9. The elevator system set forth in claim 5, wherein the at least one second magnet is disposed radially inward from the first plurality of magnets and the plurality of coils.

10. The elevator system set forth in claim 9, wherein the plurality of position sensors are disposed radially outward from the at least one second magnet, and radially inward from the plurality of coils.

11. The elevator system set forth in claim 10, wherein the plurality of position sensors are engaged to the mounting assembly.

12. The elevator system set forth in claim 11, wherein the mounting assembly includes a first panel for supporting the plurality of coils, and projecting radially inward from the stationary structure and to a distal face carried at least in-part by the first panel and that extends axially and faces radially inward, and wherein the plurality of position sensors are engaged to the distal face.

13. The elevator system set forth in claim 12, wherein the mounting assembly includes an end cap and a second panel with the plurality of coils mounted between the first and second panels, and the end cap extending between and joining the first and second panels, and wherein the distal face is carried by the end cap.

14. The elevator system set forth in claim 13, wherein the secondary portion includes a third plurality of magnets with the plurality of coils and at least a portion of the first and second panels disposed between and spaced from the first and third plurality of magnets.

15. The elevator system set forth in claim 13, wherein each one of the plurality of position sensors include at least one electrical lead routed through a conduit defined between the first and second panels.

16. The elevator system set forth in claim 5, wherein the at least one second magnet is disposed radially outward from the first plurality of magnets and the plurality of coils.

17. The elevator system set forth in claim 16, wherein the plurality of position sensors are disposed radially outward from the at least one second magnet and from the plurality of coils.

18. The elevator system set forth in claim 17, wherein the plurality of position sensors are engaged to the mounting assembly.

19. The elevator system set forth in claim 18, wherein the mounting assembly includes a bracket engaged to the stationary structure and a panel projecting radially inward from and engaged to the bracket, wherein the plurality of coils are mounted to the panel, and wherein the plurality of position sensors are engaged to the bracket.

20. The elevator system set forth in claim 19, wherein each one of the plurality of position sensors include an electrical lead, and wherein the bracket is at least in-part a bus for routing the electrical leads.

21. The elevator system set forth in claim 5, wherein the at least one second magnet is a second plurality of magnets having a pole pitch that is equal to a pole pitch of the first plurality of magnets divided by an integer of two or greater.

22. A position detection assembly for determining the position of an elevator car configured to travel in a hoistway defined by a stationary structure, the position detection assembly comprising:
at least one magnetic field sensor disposed in the hoistway and engaged to one of the car and the stationary structure; and
at least one magnet disposed in the hoistway and engaged to the other of the car and the stationary structure, the at least one magnet including a magnetic field detectable by the at least one magnetic field sensor for continuous position determination of the car within the hoistway.

23. A method of determining a position of an elevator car comprising:
sensing a magnetic field characteristic by a sensor secured to a hoistway, wherein the magnetic field characteristic is created at least in part by a permanent magnet of a propulsion system carried by the elevator car; and
comparing an output of the sensor to a pre-established tabulation based on current and phase angle intervals preprogramed into a controller.
